(19) United States
(12) Patent Application Publication
(10) Pub. No.: US 2026/0070492 A1
(43) Pub. Date: Mar. 12, 2026

(54) Solo Loading Dirt Bike Carrier

(71) Applicant: LMS Manager LLC (DBA Mockins), Brooklyn, NY (US)

(72) Inventor: Peretz Mockin, New York, NY (US)

(21) Appl. No.: 19/304,581

(22) Filed: Aug. 19, 2025

Related U.S. Application Data
(60) Provisional application No. 18/445,681, filed on Sep. 7, 2024.

(51) Int. Cl. B60R 9/10; B62H 3/08

(52) U.S. Cl. CPC B60R 9/10; B62H 3/08

(57) ABSTRACT

Systems and methods related to solo leading dirt bike carriers are disclosed herein. A bike carrier assembly may include a hitch mount configured to attach to a vehicle, a swivel joint, a carrier platform attached to the hitch mount via the swivel joint, and a positioning rod configured to be inserted through the carrier platform and at least a portion of the hitch mount. When the carrier platform is in a carrier position, the carrier platform may be supported by the positioning rod and the swivel joint; when the carrier platform is in a ramp position, the carrier platform may be supported by the swivel joint and not the positioning rod. A user may easily change the bike carrier assembly from the ramp position (for easy loading and unloading of a variety of bike-type vehicles) to the carrier position (for easy transport of the loaded bike type-vehicle) and back again.

### CROSS REFERENCE TO RELATED APPLICATIONS

This application claims the benefit of U.S. Patent Application No. 63/692,060, filed September 7, 2024, which is incorporated by reference herein in its entirety for all purposes.

### BACKGROUND

The present description relates to bike carriers. Dirt bike carriers have long been used to transport motorcycles and other two-wheeled vehicles on the back of cars, trucks, and other motor vehicles. These carriers typically attach to a vehicle's trailer hitch and provide a platform for securing and transporting a dirt bike or motorcycle. Traditional carriers often require the use of ramps for loading and unloading, which can be cumbersome and may require assistance from another person.

The process of loading a dirt bike onto a carrier can be challenging, especially for individuals attempting to do so alone. Maneuvering a heavy motorcycle up a narrow ramp while maintaining balance can be physically demanding and potentially dangerous. This difficulty is compounded when loading must be done on uneven terrain or in tight spaces where proper ramp placement may not be feasible. Existing carrier designs have attempted to address some of these challenges through various means. For example, some carriers incorporate built-in ramps that can be folded or stored when not in use. However, many of these solutions still require considerable physical effort from the user and may not fully eliminate the need for assistance during the loading process.

Additionally, the security and stability of the transported vehicle during transit are paramount concerns. Carriers must be designed to withstand the dynamic forces experienced during travel, including acceleration, braking, and cornering. Proper tie-down points and securing mechanisms are necessary to prevent movement or shifting of the loaded vehicle, which could potentially lead to damage or accidents.

The weight capacity of dirt bike carriers is another consideration, as they must be capable of safely supporting the mass of increasingly heavy motorcycles, including larger adventure bikes and electric motorcycles. This requirement often results in carriers that are themselves quite heavy, which can impact the handling characteristics of the towing vehicle and may approach or exceed the weight limits of some vehicle hitch receivers.

As the popularity of motorcycling and off-road riding continues to grow, there is an ongoing need for improved carrier designs that can address these various challenges. Enhancing the ease of use, safety, and versatility of dirt bike carriers remains an area of focus for manufacturers and enthusiasts alike.

### SUMMARY

This disclosure relates to a versatile motorcycle carrier hitch mount designed for the dependable transport of various two-wheeled vehicles, including motorcycles, dirt bikes, scooters, and e-bikes. This innovative carrier features a tilting mechanism that facilitates easy loading and unloading of vehicles. The carrier may include a platform with dimensions suitable for accommodating a wide range of tire sizes and vehicle weights.

A bike carrier may include a carrier platform that can tilt to create a ramp. The carrier may incorporate a tilting mechanism that allows the user to lower the platform, creating a ramp for effortless loading. A user may load the dirt bike while the carrier platform is positioned as a ramp, then can lift the lower side of the carrier platform so that it is in a horizontal position. The user may secure the carrier platform with a positioning rod. The swivel point of the carrier platform may be positioned such that at least a portion of the dirt bike on one side of the carrier platform provides a counterbalance, assisting the user in lifting the other side of the carrier platform. Once the bike is in place, the platform may be lifted and secured for transport. The carrier may be constructed from durable, weather-resistant materials to withstand various environmental conditions during use.

The bike carrier may attach (e.g., via a hitch) to a towing vehicle. In specific embodiments, the carrier may be constructed to fit standard vehicle hitch receivers while maintaining a relatively light weight for ease of installation and removal. The design may allow for use with various types of vehicles, including cars, SUVs, and trucks, providing flexibility for different transportation needs.

In specific embodiments, the bike carrier may include one or more of the following features. The bike carrier may include a wheel latch to lock the bike in place and prevent the bike from rolling back down the ramp before the user has a chance to lift the carrier platform into the horizontal position. The wheel latch may be attached to the carrier platform via a pivot and may be adjustable. The bike carrier may include anchor points along the carrier platform to anchor securing straps for the bike. The carrier platform may be taller at the end that is tilted up in the ramp position than at the end that is tilted down in the ramp position. An extension rod may be attached to the carrier platform and protrude from the carrier platform to provide extra anchoring point for added security for the bike. The extension rod may be removable. A handle may be mounted on the carrier platform on a side of the carrier platform that tilts down to assist the user in lifting the carrier platform into the horizontal position. The carrier platform may comprise two separate frame pieces for easy packaging and assembly. The swivel joint and the positioning rod may be symmetrically placed on either side of the hitch mount. The extension rod may be able to hold the positioning rod when the carrier platform is tilted as a ramp and is not supported by the positioning rod. When held by the extension rod, the positioning rod may be easily accessible to a user when they use it to lock the carrier platform in the horizontal (e.g., transport) position. The bike carrier assembly may include a hitch stabilizer and a license plate frame. The design may also accommodate accessories such as a bracket for attaching a gas tank.

In specific embodiments of the invention, an apparatus is provided. The apparatus comprises: a hitch mount configured to attach to a vehicle, a swivel joint, a carrier platform attached to the hitch mount via the swivel joint, and a positioning rod configured to be inserted through the carrier platform and at least a portion of the hitch mount. When the carrier platform is in a carrier position, the carrier platform is supported by the positioning rod and the swivel joint; when the carrier platform is in a ramp position, the carrier platform is supported by the swivel joint and not the positioning rod.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a side view of a dirt bike carrier assembly with a secured dirt bike in accordance with specific embodiments of the inventions disclosed herein.

FIG. 2 provides an example of a three-quarter back view of the dirt bike carrier assembly with the secured dirt bike in accordance with specific embodiments of the inventions disclosed herein.

FIG. 3 provides an example of a top-side view of the dirt bike carrier assembly in accordance with specific embodiments of the inventions disclosed herein.

FIG. 4 provides an example of an isometric view of the dirt bike carrier assembly frame structure in accordance with specific embodiments of the inventions disclosed herein.

FIG. 5 provides an example of a top view of the dirt bike carrier assembly in accordance with specific embodiments of the inventions disclosed herein.

FIG. 6 provides an example of an isometric view from the hitch side of the dirt bike carrier assembly in accordance with specific embodiments of the inventions disclosed herein.

FIG. 7 provides an example of a carrier platform of the dirt bike carrier assembly split into two separate components in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for solo loading bike carriers in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Unlike traditional carriers, the carrier designs described herein eliminate the need for a separate ramp. Instead, the carrier designs feature a unique mechanism that allows the carrier to tilt into a ramp and lift back up for transport, enabling an individual to effortlessly load their bike on their own. Although referred to as a dirt bike carrier, the carrier can hold a variety of vehicles including motorcycles, scooters, train bikes, dike bikes, e-bikes, and bicycles.

A dirt bike carrier assembly (e.g., apparatus) may be configured to transport a dirt bike or similar vehicle. In specific embodiments, the dirt bike carrier assembly may include a horizontal platform structure (e.g., carrier platform) with a metal frame designed to support a dirt bike. The dirt bike carrier assembly may incorporate straps or tie-downs to secure a dirt bike to the platform. In some implementations, the dirt bike carrier assembly may be designed for attachment to a vehicle hitch or similar mounting point. The dirt bike carrier assembly may demonstrate a compact design that allows for motorcycle transport while maintaining stability through strategic placement of support structures and securing mechanisms. The dirt bike carrier assembly may feature a swivel or pivot mechanism that enables the carrier to tilt up and down. This mechanism may allow an individual to effortlessly load a bike on their own without the need for a separate ramp. In some cases, the dirt bike carrier assembly may include structural components that enable vertical movement of the platform, facilitating loading and unloading operations. The dirt bike carrier assembly may comprise a robust construction with a sturdy frame that supports the weight of a motorcycle.

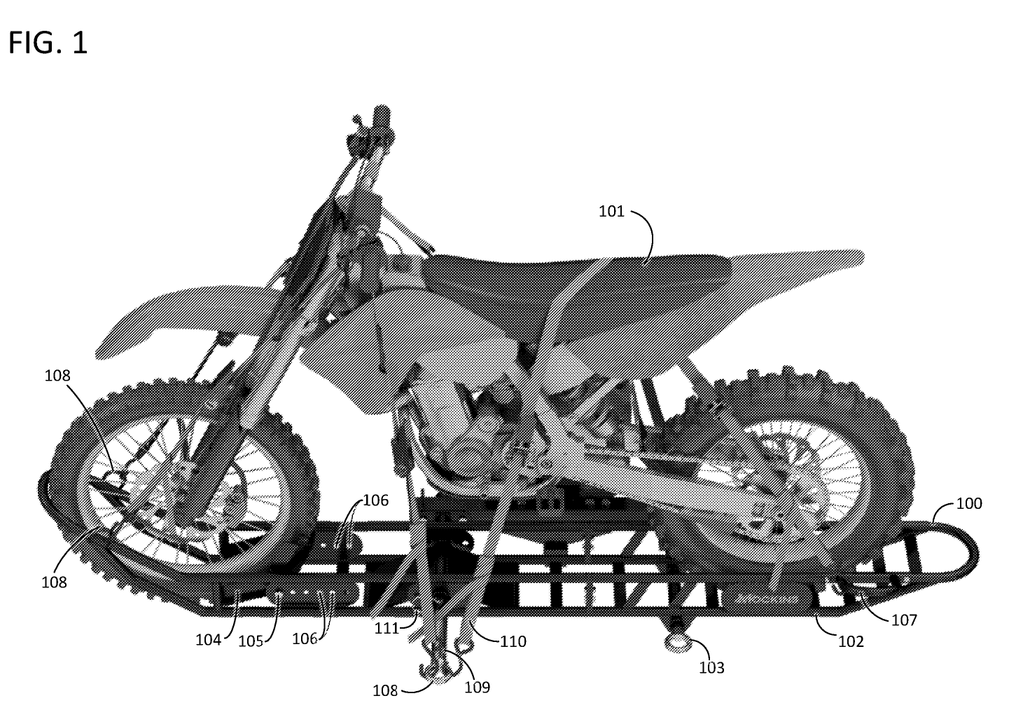

FIG. 1 provides an example of a side view of a dirt bike carrier assembly (e.g., apparatus) with a secured dirt bike in accordance with specific embodiments of the inventions disclosed herein. FIG. 1 shows dirt bike 101 mounted on bike carrier 100 and secured by straps 110. Bike carrier 100 includes carrier platform 102, which may include positioning rod 103, wheel latch 104, wheel latch pivot 105, pivot holes 106, handle 107, anchor points 108, extension rod 109, and latch 111.

Positioning rod may be (e.g., configured to be) inserted through carrier platform 102 and at least a portion of a hitch mount. When carrier platform 102 is in a carrier position (e.g., horizontal), carrier platform 102 may be supported by positioning rod 103 and a swivel joint that attaches carrier platform 102 to the hitch mount. A user may convert carrier platform 102 from the carrier position to the ramp position by removing positioning rod. When carrier platform 102 is in a ramp position, carrier platform 102 may be supported by the swivel joint but not the positioning rod. In specific embodiments, the swivel joint and positioning rod 103 may be symmetrically placed on either side of the hitch mount. The swivel joint may be positioned such that at least a portion of loaded dirt bike 101 on one side of carrier platform 102 provides a counterbalance, assisting the user in lifting the other side of carrier platform 102. For example, the front wheel of dirt bike 101 (and wheel latch 104) and the back wheel of dirt bike 101 may be on opposite sides of the swivel joint.

The ramp position may allow for easy loading of dirt bike 101 onto bike carrier 100. The user may roll the dirt bike up the ramp. In the example of FIG. 1, the front of dirt bike 101 may be loaded onto bike carrier 100 first. As dirt bike 101 is loaded onto bike carrier 100, the front wheel of dirt bike 101 may turn wheel latch 104 about wheel latch pivot 105, locking dirt bike 101 onto bike carrier 100 sufficiently securely for the user to then lift (e.g., using handle 107) the back end of carrier platform 102 with the back end of dirt bike 101 into the carrier position. The user may insert positioning rod 103 into bike carrier 100 to lock carrier platform 102 in place relative to the hitch mount.

Wheel latch 104 may contribute to the ease of loading and security of dirt bike 101; wheel latch 104 may be adjustable for different bike sizes and may hold the bike in place while the user secures the bike with straps. Wheel latch 104 may be oriented along the length of carrier platform 102 and may be adjustable along at least a portion of the length of carrier platform 102. For example, a user may move wheel latch pivot 105 to be within any pair of pivot holes 106. This versatility may allow for secure carrying of a range of bike sizes. Wheel latch may be attached to carrier platform 102 via wheel latch pivot 105 that allows wheel latch 104 to pivot about an axis directed along a width of carrier platform 102. This pivoting ability may allow dirt bike 101 to load easily. As dirt bike 101 pivots wheel latch 104, wheel latch 104 may lock, preventing dirt bike 101 from sliding back down carrier platform 102 while it is in the loading position. When unloading, wheel latch 104 may unlock, allowing dirt bike 101 to roll down carrier platform 102 while it is in the unloading position. In specific embodiments, wheel latch 104 may have an automatic lock and unlock mechanism. In specific embodiments, wheel latch 104 may be manually locked, unlocked, or both.

Bike carrier 100 may include anchor points 108 along carrier platform 102. Anchor points 108 may be used to secure straps 110 and ensure the stability of dirt bike 101. Anchor points 108 may be welded onto carrier platform 102 at various locations. Extension rod 109 may include an anchor point 108. In specific embodiments, other portions of bike carrier 100 (e.g., handle 107, various structural bars) may be used as anchor points for straps 110. In specific embodiments, some anchor points 108 may be unused while dirt bike 101 is securely strapped.

Extension rod 109 may provide extra support for dirt bike 101. Extension rod 109 may create a counter rigging point away from carrier platform 102. For example, the counter rigging point may protrude 9.5 inches away from carrier platform 102 in a direction opposite the hitch mount. In specific embodiments, extension rod 109 may be removable. For example, latch 111 may allow for removal or securing of extension rod 109. Extension rod 109 may allow customizability and easy assembly with easy packaging.

Portions of bike carrier 100, including carrier platform 102, may be made of steel (or an alloy of steel). The steel may be an anti-rust coated steel. Handle 107 may be attached (e.g., mounted) to carrier platform 102 on the side of carrier platform 102 with positioning rod 103 (e.g., the side of carrier platform 102 that is tilted down when carrier platform 102 is in the ramp position). Carrier platform 102 may be taller at the front end (with the front tire of dirt bike 101) than at the back end (with the back tire). This extra height at the front may prevent dirt bike 101 from overshooting bike carrier 100 when being loaded. The lack of extra height at the back may make loading and unloading dirt bike 101 easier. The width of carrier platform 102 may be more than 5.5 inches (e.g., 6 inches) to fit bikes with up to 5.5-inch-wide wheels. The length of carrier platform 102 may be more than 80 inches to accommodate large bikes but less than 102 inches to prevent potential driving hazards for the vehicle towing bike carrier 100. In specific embodiments, carrier platform 102 may be configured with a license plate frame to hold a license plate. In specific embodiments, bike carrier 100 may include a bracket for holding a gas tank attachment.

Positioning rod 103 may be designed to be easily inserted into and extracted from bike carrier 100. Positioning rod may include a head (e.g., a ring) at the end of a pillar. In specific embodiments, the width of the head may be larger than the width of the pillar. The extra width at the head may prevent over insertion of positioning rod 103, may make positioning rod 103 easier to grab and thus to extract, and may make positioning rod 103 easier to keep track of or less easy to lose. For example, extension rod 109 may hold positioning rod 103 when positioning rod 103 is extracted from carrier platform 102 position carrier platform 102 in the ramp position. Extension rod 109 may include a hole (e.g., an anchor point) that is larger than the pillar width of positioning rod 103 but smaller than the head width of positioning rod 103 to easily hold it and allow the user easy access to it while changing bike carrier 100 from the ramp position to the carrier position.

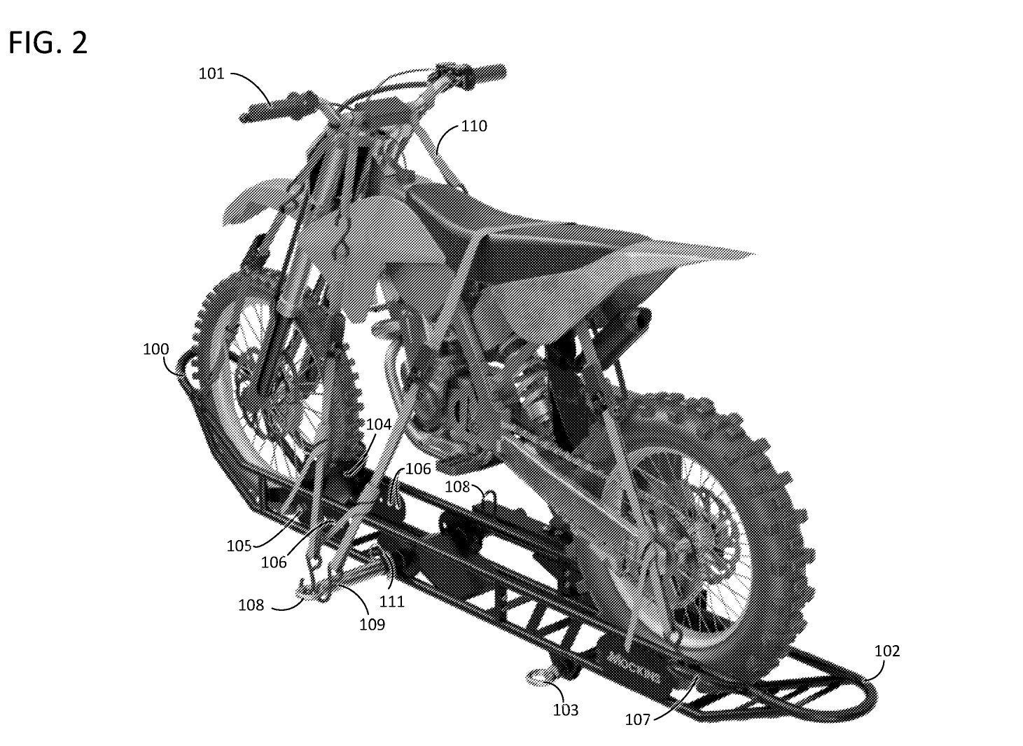

FIG. 2 provides an example of a three-quarter back view of the dirt bike carrier assembly with a dirt bike mounted in accordance with specific embodiments of the inventions disclosed herein. FIG. 2 shows dirt bike 101 mounted on bike carrier 100 and secured by straps 110. Bike carrier 100 includes carrier platform 102, which may include positioning rod 103, wheel latch 104, wheel latch pivot 105, pivot holes 106, handle 107, anchor points 108, extension rod 109, and latch 111.

In specific embodiments, the bike carrier assembly may include a lifting mechanism operatively coupled to the carrier platform and configured to raise and lower the carrier platform between a loading position and a transport position. The lifting mechanism may comprise a hydraulic or pneumatic system to assist in raising and lowering the carrier platform.

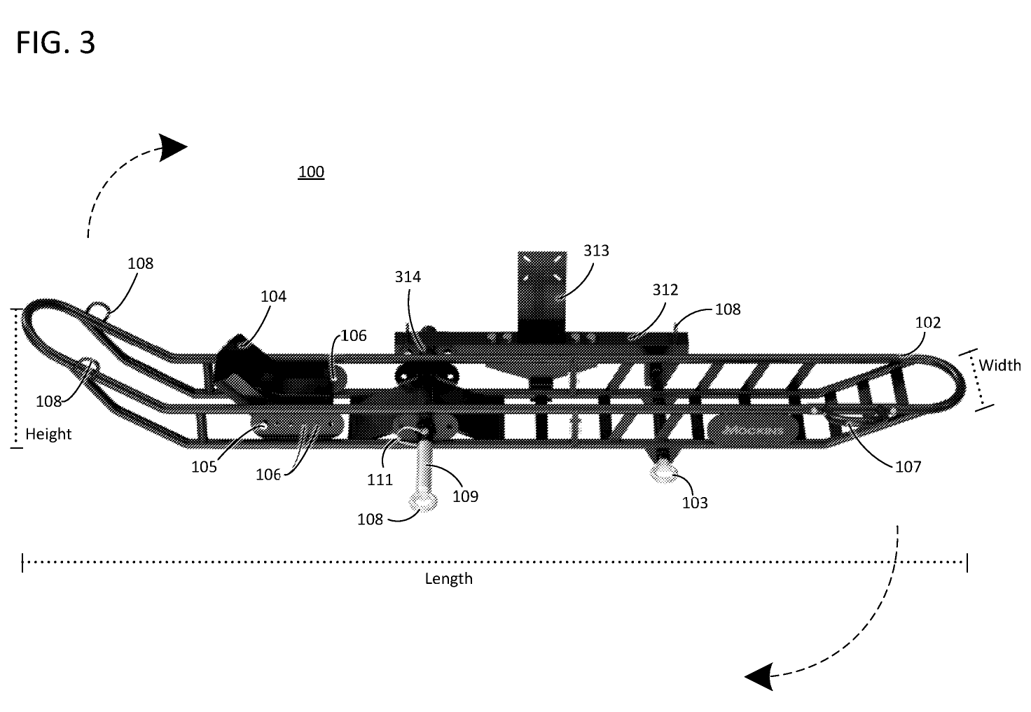

FIG. 3 provides an example of a top-side view of the dirt bike carrier assembly in accordance with specific embodiments of the inventions disclosed herein. FIG. 3 shows bike carrier 100 with carrier platform 102 and hitch mount 312. FIG. 3 also shows bracket 313, which may be a part of hitch mount 312, and swivel joint 314 connecting hitch mount 312 and carrier platform 102.

Positioning rod may be (e.g., configured to be) inserted through carrier platform 102 and at least a portion of hitch mount 312. When carrier platform 102 is in a carrier position (e.g., horizontal position, transport position), carrier platform 102 may be supported by positioning rod 103 and swivel joint 314. A user may convert carrier platform 102 from the carrier position to the ramp position by removing positioning rod 103. When carrier platform 102 is in a ramp position, carrier platform 102 may rotate clockwise about swivel joint 314 until the right end of carrier platform 102 reaches the ground or (in specific embodiments) until an internal mechanism prevents further rotation. In the ramp position, carrier platform 102 may be supported by swivel joint 314 but not by the (removed) positioning rod. In specific embodiments, swivel joint 314 and positioning rod 103 may be symmetrically placed on either side of the hitch mount. For example the length distance from the center of the hitch mount to swivel joint 314 may be the same as the length distance from the center of the hitch mount to positioning rod 103 in the other direction. Swivel joint 314 may be positioned such that at least a portion of a loaded dirt bike on one side of carrier platform 102 provides a counterbalance, assisting the user in lifting the other side of carrier platform 102. For example, a first wheel of the dirt bike may be inserted into wheel latch 104 on one side of swivel joint 314 while the other wheel of the dirt bike may be on the other side of swivel joint 314.

Portions of bike carrier 100, including carrier platform 102 and hitch mount 312, may be made of steel (or an alloy of steel). The steel may be an anti-rust coated steel. Handle 107 may be attached (e.g., mounted) to carrier platform 102 on the side of carrier platform 102 with positioning rod 103 (e.g., the side of carrier platform 102 that is tilted down when carrier platform 102 is in the ramp position). The width of carrier platform 102 may be more than 5.5 inches (e.g., 6 inches) to fit bikes with up to 5.5-inch-wide wheels. The length of carrier platform 102 may be more than 80 inches to accommodate large bikes but less than 102 inches to prevent potential driving hazards for the vehicle towing bike carrier 100. In specific embodiments, carrier platform 102 may be configured with a license plate frame to hold a license plate. In specific embodiments, hitch mount 312 may include bracket 313 for holding a gas tank attachment, a water tank attachment, or other object.

Positioning rod 103 may be designed to be easily inserted into and extracted from bike carrier 100. Positioning rod may include a head (e.g., a ring) at the end of a pillar. In specific embodiments, the width of the head may be larger than the width of the pillar. The extra width at the head may prevent over insertion of positioning rod 103, may make positioning rod 103 easier to grab and thus to extract, and may make positioning rod 103 easier to keep track of or less easy to lose. For example, extension rod 109 may hold positioning rod 103 when positioning rod 103 is extracted from carrier platform 102 position carrier platform 102 in the ramp position. Extension rod 109 may include a hole (e.g., anchor point) that is larger than the pillar width of positioning rod 103 but smaller than the head width of positioning rod 103 to easily hold it and allow the user easy access to it while changing bike carrier 100 from the ramp position to the carrier position.

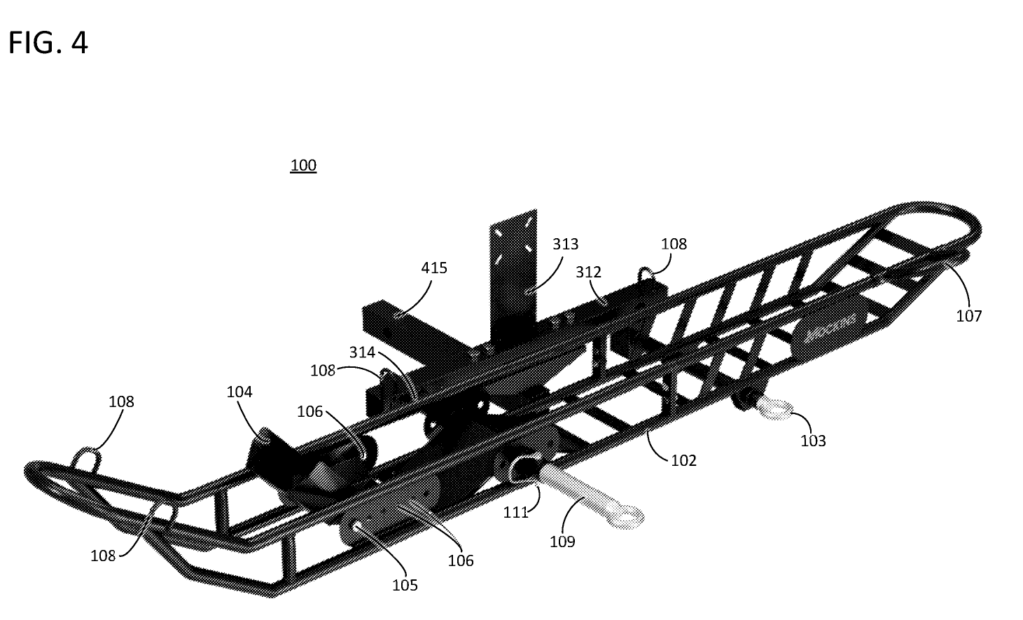

FIG. 4 provides an example of an isometric view of the dirt bike carrier assembly frame structure in accordance with specific embodiments of the inventions disclosed herein. FIG. 4 shows bike carrier 100 with carrier platform 102 and hitch mount 312. FIG. 4 also shows hitch receiver 415, which may be a part of hitch mount 312. Hitch mount 312 may attach (e.g., configured to attach) to a vehicle that may then carry or tow bike carrier 100. Hitch receiver 415 may be 2-inch receiver for universal compatibility. Bracket 313 may attach to a gas tank or gas tank attachment. The gas tank may sit on a part of hitch receiver 415. A hitch stabilizer (not shown) may be coupled to the hitch mount. For example, the hitch stabilizer may encircle a part of hitch receiver 415. In specific embodiments, swivel joint 314 and positioning rod 103 may be symmetrically placed on either side of the hitch mount. For example the length distance from hitch receiver 415 to swivel joint 314 may be the same as the length distance from the hitch receiver 415 to positioning rod 103 in the other direction.

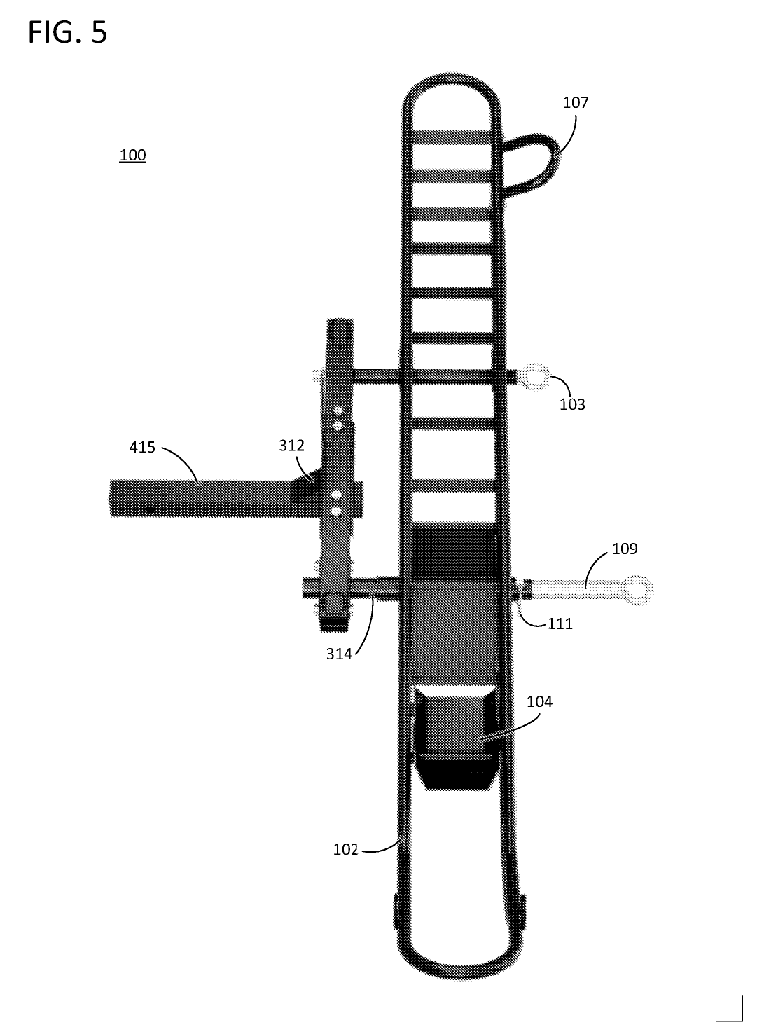

FIG. 5 provides an example of a top view of the dirt bike carrier assembly in accordance with specific embodiments of the inventions disclosed herein. FIG. 5 shows bike carrier 100 with carrier platform 102 and hitch mount 312. Bracket 313 may hold a gas tank attachment (not shown). The gas tank attachment may sit on the hitch receiver side of bracket 313 (e.g., opposed to the carrier platform side).

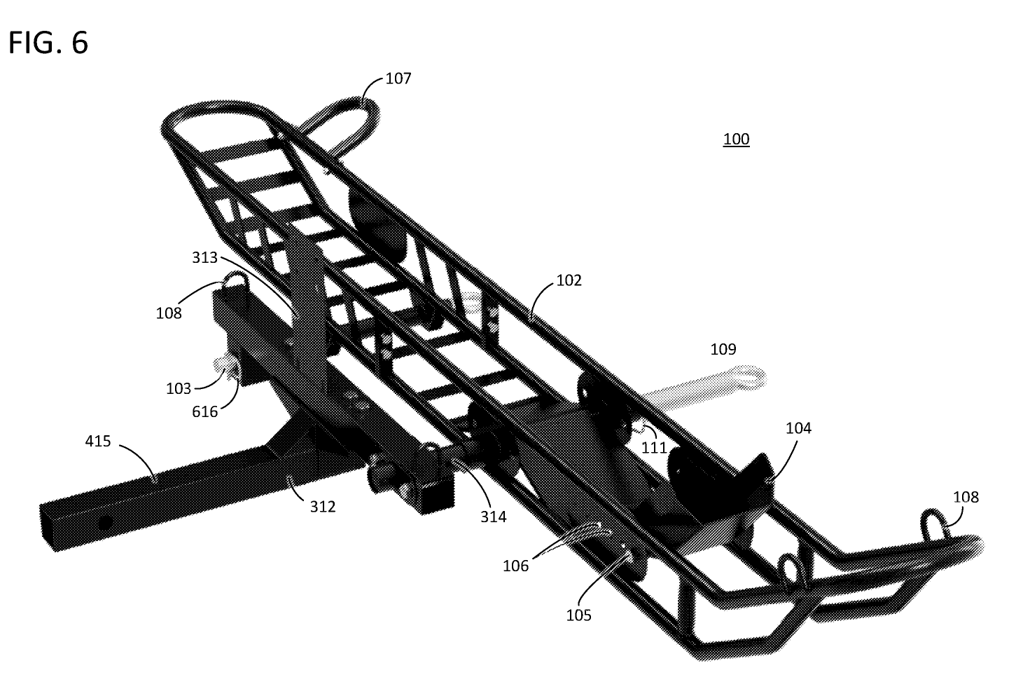

FIG. 6 provides an example of an isometric view from the hitch side of the dirt bike carrier assembly from the in accordance with specific embodiments of the inventions disclosed herein. Positioning rod 103 may include latch 616 to secure it in place.

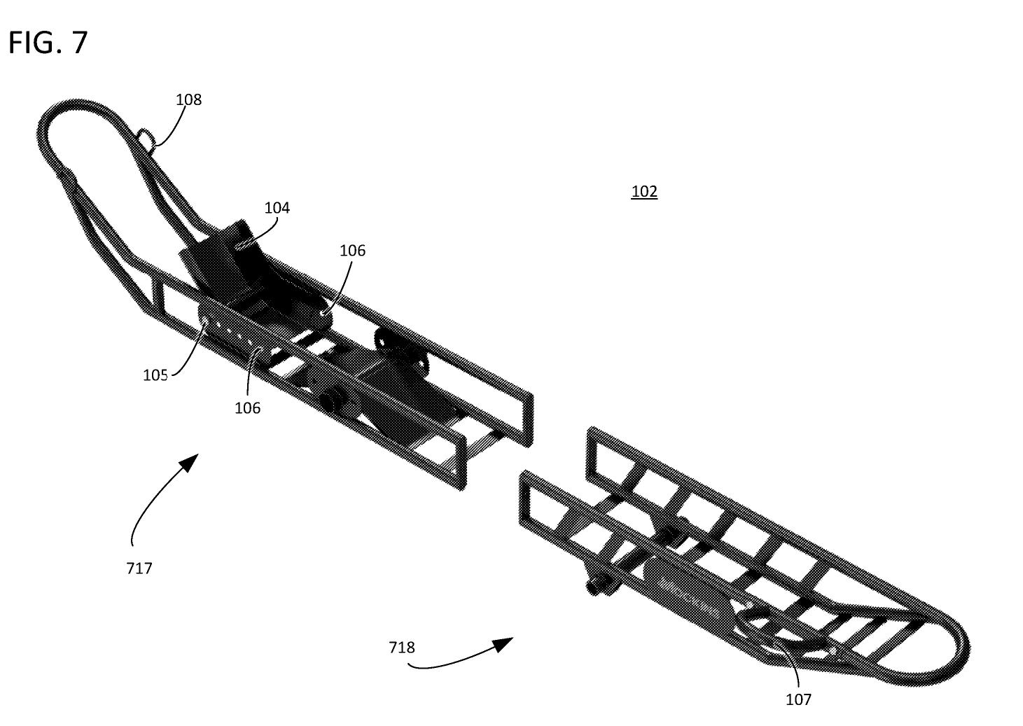

FIG. 7 provides an example of the carrier platform 102 split into separate components in accordance with specific embodiments of the inventions disclosed herein. In specific embodiments, carrier platform 102 may comprise frame piece 717 and frame piece 718. The carrier platform comprising two separate frame pieces offers several advantages. This design may facilitate easier shipping and storage, as the disassembled carrier can be packaged more compactly. Assembly may be straightforward, allowing users to quickly put the carrier together when needed. The two-piece construction may also provide flexibility in terms of replacement or repair, as individual sections could potentially be replaced if damaged without requiring a full carrier replacement. Additionally, this modular approach may allow for future upgrades or customizations, where one section could be modified or swapped out to accommodate different vehicle types or specialized features while maintaining compatibility with the existing components.

The bike carrier assembly may include a tilting ramp (e.g., a pivoting carrier platform) for various terrains. The tilting ramp of this bike carrier assembly (e.g., motorcycle hitch carrier) makes loading effortless on different terrains. The user may simply adjust the angle of the tilt to suit the environment, whether the user is on a steep incline or a flat surface. This makes loading and unloading dirt bikes, motorcycles, scooters, e-bikes, and more an easy task, saving time and energy. The bike carrier assembly may be or include a versatile carrier hitch mount that is for dependable transport of various vehicles. In specific embodiments, the bike carrier assembly may have an 83-inch-long and a 6-inch-wide platform, and may support fat tires up to 5.5 inches wide & bikes up to 500 lbs. In specific embodiments, the bike carrier assembly may weigh around 60 pounds and may fit (e.g., attach to) any towing vehicle with a 2-inch receiver. The bike carrier assembly makes hauling easy—whether on a car, SUV, truck, etc. The hitch mount may fit a variety of vehicles, ensuring a stable ride even on bumpy or uneven terrain. Installing the bike carrier assembly (e.g., scooter hitch carrier) is easy; letting a user hit the road quickly and securely.

In specific embodiments, the bike carrier assembly may have a heavy-duty load capacity of 600 lbs. For example, the dirt bike hitch carrier may support up to 600 pounds, making it capable of transporting large bikes such as dirt bikes, e-bikes, trail bikes, and motorcycles. In specific embodiments, the bike carrier assembly may have a durable all-steel construction with a weatherproof finish. For example, the bike carrier assembly may be made from high-quality, weatherproof, and corrosion-resistant steel; this trailer hitch bike carrier may be designed for long-lasting durability. The full steel frame construction provides strength, making it ideal for rough outdoor adventures in any weather conditions.

The bike carrier assembly may provide for an easy loading process. The bike carrier assembly (e.g., motorcycle trailer) may offer a hassle-free loading and unloading experience. To load, a user may simply remove the pin, rotate (e.g., tilt) the carrier platform (e.g., e-bike rack) downward, roll their bike up until the tire locks into place. Once secured, the user may lift the carrier platform (e.g., dirt bike trailer), reinsert the pin, and strap the bike down for transport. This simple process ensures quick and easy loading.

The bike carrier assembly may use an innovative upgraded design with anti-sway stability. The bike carrier assembly may provide smooth rides, for example by featuring a hitch stabilizer and anti-sway design for a rattle-free experience on rugged terrain. The anchor points on the bike carrier assembly may be placed to allow straps to keep the user's bike secure and prevent shifting during transport. The bike carrier assembly may ensure enhanced stability and a quieter ride on uneven roads. This bike carrier assembly (e.g., eBike carrier hitch mount) may also be designed with a license plate holder and bracket for attaching a small gas tank. The bike carrier assembly may be the ideal blend of durability and convenience.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to dirt bikes, any wheeled vehicle may be used where carriers for vehicles with more than two wheels may be appropriately modified. These and other modifications and variations to the present invention may be practiced by those skilled in the art, without departing from the scope of the present invention, which is more particularly set forth in the appended claims.

What is claimed is:

1. An apparatus comprising:
a hitch mount configured to attach to a vehicle;
a swivel joint;
a carrier platform attached to the hitch mount via the swivel joint; and
a positioning rod configured to be inserted through the carrier platform and at least a portion of the hitch mount;
wherein when the carrier platform is in a carrier position, the carrier platform is supported by the positioning rod and the swivel joint; and
wherein when the carrier platform is in a ramp position, the carrier platform is supported by the swivel joint and not the positioning rod.

2. The apparatus of claim 1, further comprising:
a wheel latch oriented along a length of the carrier platform.

3. The apparatus of claim 2, wherein:
the wheel latch is adjustable along at least a portion of the length of the carrier platform.

4. The apparatus of claim 2, wherein:
the wheel latch is attached to the carrier platform via a pivot that allows the wheel latch to pivot about an axis directed along a width of the carrier platform.

5. The apparatus of claim 1, further comprising:
anchor points along the carrier platform.

6. The apparatus of claim 1, wherein:
the carrier platform is taller at a first end than at a second end.

7. The apparatus of claim 1, further comprising:
an extension rod attached to the carrier platform and protruding from the carrier platform in a direction opposite the hitch mount.

8. The apparatus of claim 7, wherein:
the extension rod is removable from the carrier platform.

9. The apparatus of claim 1, further comprising:
a handle attached to the carrier platform on a side of the carrier platform with the positioning rod.

10. The apparatus of claim 1, wherein:
the carrier platform comprises two separate frame pieces.

11. The apparatus of claim 1, wherein:
a width of the carrier platform is more than 5.5 inches.

12. The apparatus of claim 1, wherein:
a length of the carrier platform is more than 80 inches.

13. The apparatus of claim 1, wherein:
a length of the carrier platform is less than 102 inches.

14. The apparatus of claim 1, wherein:
the carrier platform is made of steel.

15. The apparatus of claim 1, further comprising:
a bracket for holding a gas tank attachment.

16. The apparatus of claim 1, wherein:
the swivel joint and the positioning rod are symmetrically placed on either side of the hitch mount.

17. The apparatus of claim 1, wherein:
the positioning rod comprises a head and a pillar; and
a width of the head of the positioning rod is larger than a width of the pillar of the positioning rod.

18. The apparatus of claim 17, further comprising:
an extension rod including a hole;
wherein the hole is larger than the width of the pillar of the positioning rod but smaller than the width of the head of the positioning rod.

19. The apparatus of claim 1, further comprising:
a hitch stabilizer coupled to the hitch mount.

20. The apparatus of claim 1, further comprising:
a license plate frame configured to attach to the carrier platform.
